(19) United States
(12) Patent Application Publication
(10) Pub. No.: US 2006/0142052 A1
(43) Pub. Date: Jun. 29, 2006

(54) Dual-mode GSM/PHS mobile phone adopting a single antenna

(75) Inventors: Cheng-Shing Lai, Taipei (TW); Xiao-Long Fan, Nanking (CN); Ning Liu, Nanking (CN); Hong-Bin Zhang, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/159,302

(22) Filed: Jun. 23, 2005

(30) Foreign Application Priority Data
Dec. 23, 2004 (TW) 093140199

(51) Int. Cl. H04B 1/44; H04M 1/00

(52) U.S. Cl. 455/552.1; 455/83

(57) ABSTRACT

A GSM/PHS dual-mode mobile phone adopting a single antenna includes an antenna separately connected to a GSM module and a PHS module through an antenna module, and the antenna module is connected to a central processing unit for receiving a control signal transmitted from the central processing unit to switch its connection between the modules, so as to select the GSM or PHS operating mode and carry out the detection and transmission of a signal with a frequency of 900 MHz or 1900 MHz at the GSM or PHS operating mode.

### FIELD OF THE INVENTION

The present invention generally relates to mobile phones, and more particularly to a dual-mode GSM/PHS mobile phone adopting a single antenna to detect, receive and transmit signals with frequency of 900 MHz or 1900 MHz, enabling user to ring a phone or receive and send messages through an appropriate mode.

### BACKGROUND OF THE INVENTION

In recent years, a second-generation digital wireless telephone system known as personal handy-phone system (PHS) becomes very popular in the wireless communication product market, and the PHS mobile phone is a low-power mobile phone used in slow moving occasions and is generally be used in subways or malls underground. The PHS mobile phone features a lightweight and compact design, a long-hour calling time, and a high-speed transmission. Although the PHS technology is not an edge technology, it is very practical and perfectly fit for the low-end markets. In general, a PHS mobile phone has the major advantages as follows:

(1) The PHS mobile phone comes with simple components and a low cost, not just lower than traditional telephone systems but also lower than the cellular mobile communication systems.

(2) The average sales revenue of each user is significantly higher than that of the traditional telephones.

(3) The PHS mobile phone fully uses the idle network resources of a current fixed network, so as to enhance the value of a fixed network. The PHS mobile phone not only cuts down the installation cost, but also expedites the construction of networks.

(4) The PHS mobile phone costs less on the rate per call and has a certain level of mobility, which meets the requirements of general metropolitan users.

Based on the foregoing advantages, the life and work for people living in a city require a mobility of both high or low speed level as well as the quality and cost for near and far telephone communications. In general, a global system for mobile communication (GSM) mobile phone and a PHS mobile phone have been accomplished the requirements and the options of different environments, and thus users usually carry both kinds of mobile phones with them. Such phenomenon causes tremendous inconvenience to users. In view of the aforementioned shortcoming, some mobile phone manufacturers combine the GSM mobile phone and the PHS mobile phone that operate in different communication network systems, and launched various popular dual-mode models to meet the needs of the extensive mobile phone market. A user just needs to carry a dual-mode GSM/PHS mobile phone for making and receiving telephones through the two different modes of the GSM and PHS communication network systems.

On one hand, the dual-mode mobile phone can match customer's need of a low average phone charge; on the other hand, the dual-mode mobile phone can make up for the insufficient coverage of the PHS network. Further, a dual-mode mobile phone offers two telephone numbers to respectively operate in the GSM communication mode and the PHS communication mode, The GSM communication mode operates at a frequency of 900 MHz (or 1,800 MHz), and the PHS communication mode operates at a frequency of 1900 MHz. The advantages of the dual-mode GSM/PHS mobile phone which owns two modes in a mobile phone are no interference happened between each other and can be shifted reciprocally by a press switch. Furthermore, the low phone charge of the dual-mode mobile phone easily helps business men to penetrate the new market of the dual-mode mobile telephone consumers who do not use the mobile phone of PHS. For the above reasons, mobile phone manufacturers aggressively develop dual-mode mobile phone design associated for a substantial market share in the new dual-mode mobile phone market.

At present, various dual-mode mobile phones are still designed to employ a design of dual antennas. In other words, either a communication mode involves an antenna and its own related circuits for the signal transmissions. However, it causes a serious issue, which lacks of the installation space of allocating the components and the circuits in a dual-mode GSM/PHS mobile phone without discarding the original lightweight and compact design of the mobile phone.

Therefore, it becomes an important subject for the mobile phone manufacturers to simplify the structure and component usage of a dual-mode mobile phone, effectively lessen the production cost and reinforce the competitiveness of product while remaining the lightweight and compact design of the original GSM mobile phone or PHS mobile phone.

### SUMMARY OF THE INVENTION

In view of the shortcomings of the prior art dual-mode mobile phones requiring dual antennas and having difficulties of reducing the size of a dual-mode mobile phone or maintaining the original light, thin, short and compact design due to the installation of antennas and related circuits, the inventor of the present invention based on years of experience in the mobile phone related industry to conduct extensive researches and experiments to overcome the shortcomings of the prior art and finally invented a dual-mode GSM/PHS mobile phone adopting a single antenna in accordance with the present invention.

Therefore, it is an objective of the present invention to provide a dual-mode GSM/PHS mobile phone adopting a single antenna, which includes an antenna separately connected to a GSM module and a PHS module through an antenna module, and the antenna module is connected to a central processing unit for receiving a control signal transmitted from the central processing unit to switch its connection with the modules, so as to select the GSM or PHS operating mode and carry out the detection and transmission of a signal having a 900 MHz or 1900 MHz frequency under the GSM or PHS operating mode.

Another objective of the present invention is to preset the antenna module, and switch the operating mode to a frequency range of 900 MHz or 1900 MHz according to the intensity of the signals of the different GSM or PHS frequency, so that the dual-mode mobile phone fits the operating mode and uses the single antenna for ringing or receiving signals. The present invention not only makes the dual-mode mobile phone more user-friendly, but also effectively reduces the inner space of the dual-mode mobile phone due to simplifying the components in order to lessen the production cost, so that the designed dual-mode mobile phone remains the feature of light, thin, short and compact design.

A further objective of the present invention is to include a first double pole double throw (DPDT) switch in the antenna module; wherein a common contact point of the first DPDT switch is connected to the antenna and the other two contact points are connected respectively to a duplexer and a contact point of a second DPDT switch, and a common contact point of the second DPDT switch is connected to a signal transmitting/receiving terminal of the GSM module, and the other contact point is connected to a contact point of the duplexer, and the other contact point of the duplexer is connected to the signal transmitting/receiving terminal. The DPDT switch is controlled by a switch signal transmitted from the central processing unit, so that when a switch is made, the second DPDT switch is driven to switch simultaneously. If the dual-mode mobile phone is controlled by the switch signal SW and switched to the GSM mode, then the first DPDT switch and the second DPDT switch are switched to the GSM mode for transmitting or receiving signals through the antenna without going through the duplexer status.

Another further objective of the present invention is to control the dual-mode mobile phone by the switch signal SW, such that when the dual-mode mobile phone is switched to a PHS/GSM dual mode, a GSM/PHS dual mode or a PHS operating mode, the first DPDT switch and the second DPDT switch are switched, such that the GSM module or the PHS module must go through the duplexer and signal transmitting or receiving status of the antenna.

Another objective of the present invention is to filter the signal passing through the duplexer according to the signal intensity of the GSM or PHS frequency and follow a predetermined setup sequence as well as the signal intensity to select an appropriate operating frequency of 900 MHz or 1900 MHz of the dual-mode mobile phone, so that a user can ring or receive signals according to the appropriate operating mode selected by the duplexer.

The above and other objects, features and advantages of the present invention will become apparent from the following detailed description taken with the accompanying drawings.

### BRIEF DESCRIPTION OF THE DRAWINGS

FIG. 1 is a schematic view of a system architecture of the present invention;

FIG. 2 is a schematic view of a circuit of an antenna module according to a preferred embodiment of the present invention; and

FIG. 3 is a flow chart of switching the operating mode in accordance with a preferred embodiment of the present invention.

### DETAILED DESCRIPTION OF THE PREFERRED EMBODIMENTS

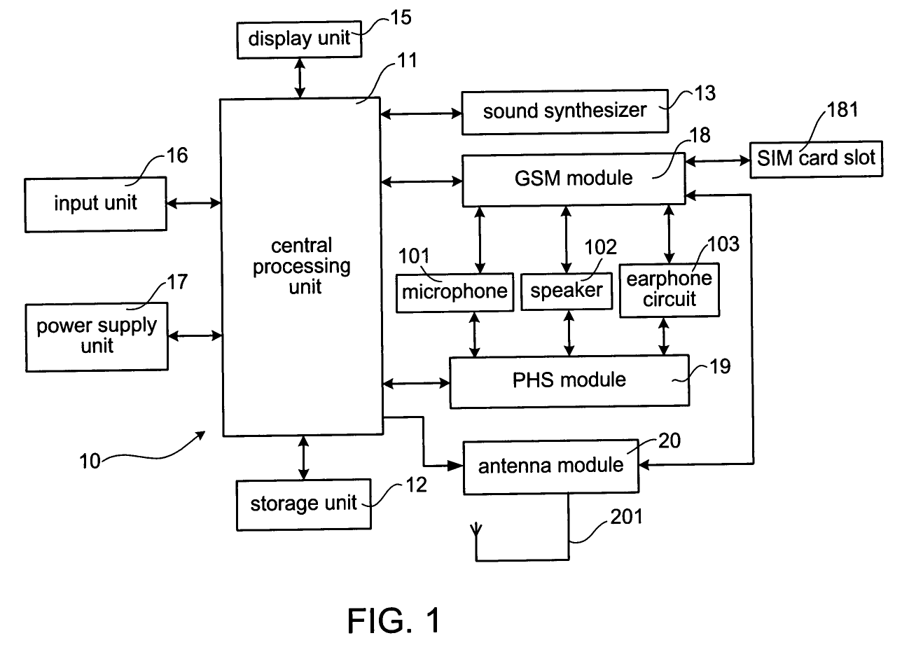

Referring to FIG. 1, a dual-mode GSM/PHS mobile phone adopting a single antenna is illustrated. The dual-mode mobile phone comes with only one antenna 201 that can enter into a selected GSM operating mode or a PHS operating mode and carries out a detection and a transmission/receiving of a 900 MHz or a 1900 MHz signal under the GSM or PHS operating mode, or the dual-mode mobile phone selects to switch the operating mode to a 900 MHz or a 1900 MHz frequency range according to a predetermined setup sequence and the signal intensity of the GSM or PHS frequency, so that the dual-mode mobile phone can dial phone calls or receive signals with an appropriate operating mode through the single antenna.

Referring to FIG. 1 again, the dual-mode mobile phone 10 of a preferred embodiment comprises a central processing unit 11 for controlling related components and circuits in the dual-mode mobile phone 10 and keeping a normal operation of the dual-mode mobile phone 10; a storage unit 12, having at least one set of memories and coupled with the central processing unit 11 for providing memory spaces to store the software and data required for a normal operation of the dual-mode mobile phone 10; a sound synthesizer 13 coupled to the central processing unit 11 for synthesizing digital sound effects according to the order of the central processing unit 11; a display unit 15 being a liquid crystal display coupled with the central processing unit 11 for displaying the desired numeric, textual or graphic signals of the central processing unit 11; an input unit 16 being a press button set coupled with the central processing unit 11 for inputting textual or numeric signals by users; a power supply unit 17 being a battery set coupled with the central processing unit 11 for supplying the power required by a normal operation of the components and circuits in the dual-module mobile phone 10, a GSM module 18 coupled with the central processing unit 11 for allowing the dual-mode mobile phone 10 to operate under the GSM mode and transmitting or receiving signals; a PHS module 19 coupled with the central processing unit 11 for allowing the dual-mode mobile phone 10 to operate under the PHS mode and transmitting or receiving signals.

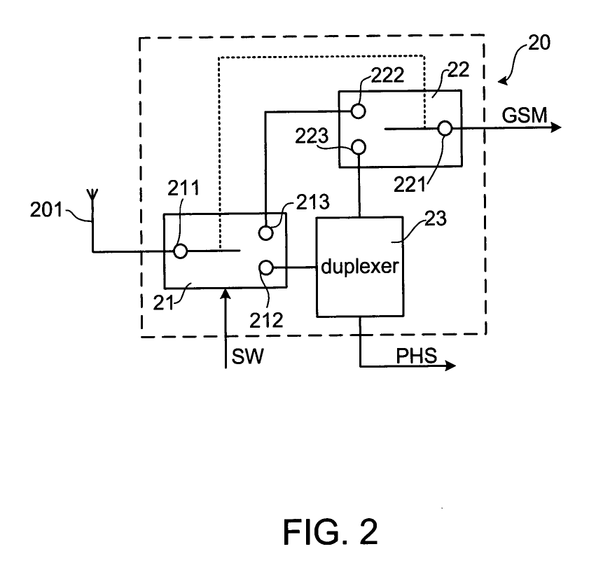

Referring to FIG. 1 for the preferred embodiment again, the GSM module 18 and the PHS module 19 are coupled separately to a microphone 101, a speaker 102 and an earphone circuit 103, so that the two modules 18, 19 enable to receive a near-end caller's voice through the microphone 101, and releases a remote-end caller's voice received by the GSM module 18 or the PHS module 19 via the speaker 102 and the earphone circuit 103. The GSM module 18 is coupled to a SIM card slot 181 to read a user ID stored in a SIM card via the slot 181. It is noteworthy that the dual-mode mobile phone 10 as shown in FIG. 1 only has a single antenna 201, and the antenna 201 is connected to the GSM module 18 and the PHS module 19 through an antenna module 20, and the antenna module 20 is connected to the central processing unit 11 for receiving a control signal transmitted from the central processing unit 11. In the preferred embodiment, the antenna module 20 as shown in FIG. 2 comprises a first double pole double throw (DPDT) switch 21 and a common contact point 211 of the DPDT switch 21 is connected with the antenna 201 and the other two contact points 212, 213 of the DPDT switch 21 are respectively connected to a duplexer 23 and a contact point 222 of a second DPDT switch 22, and a common contact point 221 of the second DPDT switch 22 is connected to a signal transmitting/receiving terminal of the GSM module 18 and the other contact point 223 of the second DPDT switch 22 is connected to the duplexer and the other contact point of the duplexer 23 is connected to a signal transmitting/receiving terminal of the PHS module 19. It is noteworthy that the first DPDT switch 21 according to this embodiment can be shifted synchronously by a switch signal SW transmitted from the central processing unit 11 to activate the second DPDT switch 22 (as indicated by the dotted line in FIG. 2).

The aforementioned antenna module 20 is only an embodiment of the present invention, but not intended to limit the invention, so that any person skilled in the art can design another antenna module according to the idea of the present invention. If a dual-mode mobile phone enable to operate under a GSM operating mode or a PHS operating mode as selected and enable to detect and transmit/receive signals of 900 MHz or 1900 MHz frequency through a single antenna, or the said dual-mode mobile phone can be switched to an appropriate operating mode according to a predetermined PHS/GSM or GSM/PHS dual mode and the different signal intensity of the GSM or PHS frequency, then the single antenna used for dialing phone calls or transmitting/receiving signals is considered as the same field of the antenna module of the present invention.

If the dual-mode mobile phone 10 is switched by the switch signal SW to the GSM mode, the first DPDT switch 21 and the second DPDT switch 22 are switched as well, so that the antenna 201, the first DPDT switch 21, the second DPDT switch 22 and the GSM module 18 in sequence constitute an electric-conducted connection, and the GSM module 18 can directly transmit/receive signals through the antenna 201 without going through the duplexer 23. If the dual-mode mobile phone is switched by the switch signal SW to the PHS/GSM dual mode, the GSM/PHS dual mode, or the PHS mode, the first DPDT switch 21 and the second DPDT switch 22 are switched through the duplexer 23, such that the antenna 201, the first DPDT switch 21, the duplexer 23, the second DPDT switch 22 and the GSM module 18 in sequence constitute an electric-conducted connection, or the antenna 201, the first DPDT switch 21, the duplexer 23 and the PHS module 19 in sequence constitute an electric-conducted connection. As a result, the GSM module 18 and the PHS module 19 enable to transmit or receive signals by the duplexer 23 through the antenna 201. Also note that the duplexer 23 in this embodiment has a filter function for signals passing through the duplexer 23, wherein only signals with a frequency of 900 MHz can pass through the GSM module 18 but the signals with a frequency of 1900 MHz are shielded; and only signals with a frequency of 1900 MHz can pass through the PHS module 19, but signals with a frequency of 900 MHz are shielded. The duplexer 23 selects the operating mode with a frequency of 900 MHz or 1900 MHz according to a predetermined sequence of a PHS/GSM dual mode, or a GSM/PHS dual mode as well as the signal intensity of the GSM or PHS frequency. Therefore, the dual-mode mobile phone can dial phone calls or transmit/receive signals with an appropriate operating mode through a single antenna.

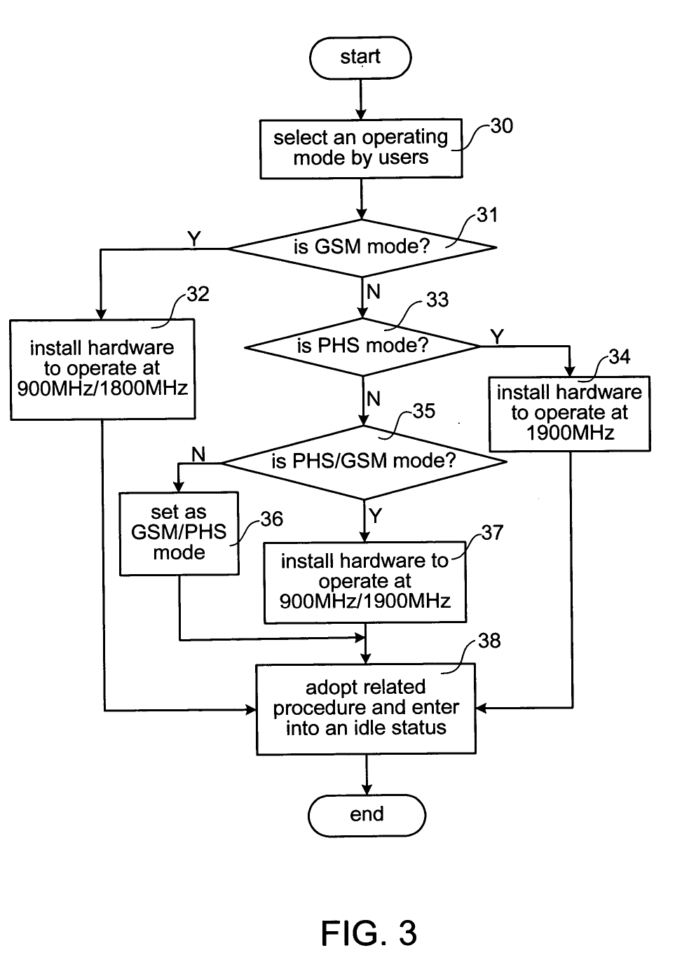

Referring to FIG. 3, the central processing unit 11 of this embodiment enables the dual-mode mobile phone 10 to operate under the GSM mode, the PHS/GSM dual mode, the GSM/PHS dual mode, or the PHS mode, such that the GSM module 18 or PHS module 19 is able to transmit or receive signals by the single antenna 201 according to the following procedure:

Step 30: Read the signal of selecting operating mode inputted by a user through the input unit 16;

Step 31: Determin whether or not the selected operating mode is the GSM mode; if yes, then go to Step 32, or else go to Step 33;

Step 32: Release a switch signal SW to the first DPDT switch 21 to switch the two switches 21, 22, so that the antenna 201, the first DPDT switch 21, the second DPDT switch 22 and the GSM module 18 in sequence constitute an electric-conducted connection, and then the GSM module 18 enables to transmit or receive signals directly without going through the duplexer 23 and operate at the GSM frequency of 900 MHz (or 1800 MHz); and then go to Step 38;

Step 33: Determine whether or not the selected operating mode is the PHS operating mode; if yes, then go to Step 34, or else go to Step 35;

Step 34: Release a switch signal SW to the first DPDT switch 21 to switch the two switches 21, 22 to go through the duplexer 23, so that the antenna 201, the first DPDT switch 21, the duplexer 23 and the PHS module 19 in sequence constitute an electric-conducted connection, and the PHS module 19 has to go through the duplexer 23 and then transmits or receives signals through the antenna 201 and operates at the PHS frequency of 1900 MHz; and then go to Step 38;

Step 35: Determine whether or not the selected operating mode is the PHS/GSM dual-mode operating mode; if yes, then go to Step 37, or else go to Step 36;

Step 36: Release a switch signal SW to the first DPDT switch 21 to switch the two switches 21, 22 to go through the duplexer 23, so that the antenna 201 constitutes an electric-conducted connection with the GSM module 18 or the PHS module 19, and then the duplexer 23 selects an appropriate operating mode for the dual-mode mobile phone according to the set sequence of GSM/PHS and the signal intensity of different frequencies; and then go to Step 38;

Step 37: Release a switch signal SW to the first DPDT switch 21 to switch the two switches 21, 22 to go through the duplexer 23, so that the antenna 201 constitutes an electric-conducted connection with the GSM module 18 or the PHS module 19, and then the duplexer 23 selects an appropriate operating mode for the dual-mode mobile phone according to the set PHS/GSM sequence and the signal intensity of different frequencies; and then go to Step 38; and

Step 38: Start the related application programs stored in the storage unit 12 after setting the related hardware and operating mode, so that the dual-mode mobile phone is ready to work as an idle mode.

In summation of the description above, the present invention not only can switch the dual-mode mobile phone 10 to the required GSM or PHS operating mode through the input unit 16, so that the GSM module 18 or the PHS module 19 can use a single antenna 201 to transmit or receive signals, or select an appropriate operating mode for the dual-mode mobile phone 10 according to the predetermined PHS/GSM or GSM/PHS sequence and the signal intensity of different frequencies, and dial a call or receive signals by the single antenna 201. Since the dual-mode mobile phone 10 of the present invention just needs a single antenna module 20 and an antenna 201, therefore the space for installing the components in the dual-mode mobile phone 10 can be reduced effectively, and the production cost could be lower. The dual-mode mobile phone produced by the foregoing design can maintain a feature of light, thin, short and compact design of the original GSM or PHS mobile phone, and also has better user-friendliness.

While the invention herein disclosed has been described by means of specific embodiments, numerous modifications and variations could be made thereto by those skilled in the art without departing from the scope and spirit of the invention set forth in the claims.

What is claimed is:

1. A GSM/PHS dual-mode mobile phone adopting a single antenna, comprising:
a central processing unit controlling related components and circuits in said dual-mode mobile phone to operate in a normal condition;
a GSM module coupled to said central processing unit for transmitting and receiving a signal at a GSM mode of said dual-mode mobile phone;
a PHS module being coupled to said central processing unit for transmitting and receiving a signal at a PHS mode of said dual-mode mobile phone;
a single antenna;
an antenna module being separately coupled to said central processing unit, said GSM module, said PHS module and said single antenna for switching a connection status between said antenna module and said GSM and PHS modules according to a control signal transmitted from said central processing unit so as to set said dual-mode mobile phone to a GSM operating mode or a PHS operating mode, thereby enabling said dual-mode mobile phone to detect, transmit and receive a signal of a frequency used in the GSM operating mode or the PHS operating mode.

2. The GSM/PHS dual-mode mobile phone adopting a single antenna of claim 1, wherein said antenna module further selects said dual-mode mobile phone to be switched to a corresponding operating mode according to a predetermined PHS/GSM or GSM/PHS sequence and the signal intensity of said GSM or PHS frequency, so as to dial a phone call or transmit or receive a signal through said single antenna.

3. The GSM/PHS dual-mode mobile phone adopting a single antenna of claim 2, wherein said antenna module further comprises:
a first dual pole dual throw (DPDT) switch having a common contact point coupled with said antenna, and said first DPDT switch is controlled to switch by a switch signal transmitted from said central processing unit;
a second DPDT switch having a common contact point coupled with a signal transmitting and receiving terminal of said GSM module, and a contact point is coupled to a contact point of said first DPDT switch and linked with a second DPDT switch for carrying out a switch when said first DPDT switch is switched; and
a duplexer being separately coupled to another contact point of said first DPDT switch and said second DPDT switch and a signal transmitting and receiving terminal of said PHS module.

4. The GSM/PHS dual-mode mobile phone adopting a single antenna of claim 3, wherein said dual-mode mobile phone is switched to a GSM mode by said switch signal, and said first DPDT switch and said second DPDT switch are switched such that said antenna, said first DPDT switch, said second DPDT switch and said GSM module in sequence constitute an electric-conducted connection and said GSM module transmits and receives a signal through said antenna.

5. The GSM/PHS dual-mode mobile phone adopting a single antenna of claim 3, wherein said dual-mode mobile phone is switched to a PHS mode by said switch signal, and said first DPDT switch and said second DPDT switch are switched to go through said duplexer, such that said antenna, said first DPDT switch, said duplexer and said PHS module in sequence constitute an electric-conducted connection and said PHS module transmits and receives a signal through said antenna.

6. The GSM/PHS dual-mode mobile phone adopting a single antenna of claim 3, wherein said duplexer filters a signal passing through said duplexer and only a signal with a corresponding frequency can pass through said GSM module or PHS module, but a signal without a corresponding frequency is shielded.

7. The GSM/PHS dual-mode mobile phone adopting a single antenna of claim 3, wherein said duplexer selects an appropriate operating mode for said dual-mode mobile phone according to a predetermined PHS/GSM or GSM/PHS sequence and the signal intensity of said GSM or PHS frequency, so as to dial a phone call or transmit or receive a signal through said single antenna.
